(19) United States
(12) Patent Application Publication
(10) Pub. No.: US 2026/0055850 A1
(43) Pub. Date: Feb. 26, 2026

(54) GAS SUPPLY DEVICE AND GAS SUPPLY METHOD

(71) Applicant: MITSUBISHI HEAVY INDUSTRIES, LTD., Tokyo (JP)

(72) Inventor: Koki FUKUDA, Tokyo (JP)

(21) Appl. No.: 19/084,755

(22) Filed: Mar. 20, 2025

(30) Foreign Application Priority Data
Aug. 22, 2024 (JP) 2024-140597

(51) Int. Cl. F17C 7/00; F17C 13/04

(52) U.S. Cl. CPC F17C 7/00; F17C 13/04; F17C 2223/0161; F17C 2225/0123; F17C 2227/0302; F17C 2250/01; F17C 2265/05; F17C 2270/01

(57) ABSTRACT

A gas supply device according to the disclosure includes a first pressure vessel in which liquefied gas is stored, a second pressure vessel configured to generate gas by vaporizing the liquefied gas supplied from the first pressure vessel, a liquefied gas supply path configured to allow the liquefied gas to selectively flow from the first pressure vessel toward the second pressure vessel, and a gas supply path configured to allow the gas generated in the second pressure vessel to selectively flow toward a gas utilization unit.

### CROSS-REFERENCE TO RELATED APPLICATIONS

This application claims the benefit of priority to Japanese Patent Application Number 2024-140597 filed on Aug. 22, 2024. The entire contents of the above-identified application are hereby incorporated by reference.

### TECHNICAL FIELD

The disclosure relates to a gas supply device and a gas supply method.

### RELATED ART

A liquid hydrogen fuel supply system including a liquid hydrogen tank in which liquid hydrogen is stored and supplying boil-off gas generated from the liquid hydrogen stored in the liquid hydrogen tank to, for example, a fuel cell is known. Since the boil-off gas of hydrogen generated from the liquid hydrogen stored in the liquid hydrogen tank depends on the heat insulating treatment of the liquid hydrogen tank, the generation amount of the boil-off gas is small, and the pressure of the boil-off gas to be supplied to the fuel cell sometimes does not sufficiently increase.

JP 2006-200563 A discloses a liquid hydrogen fuel supply system including, in addition to a liquid hydrogen tank that stores liquid hydrogen and generates boil-off gas, three filling tanks that are filled with the boil-off gas through a communication path communicating with the liquid hydrogen tank.

In the three filling tanks of the liquid hydrogen fuel supply system of JP 2006-200563 A, filling start pressures at which the three filling tanks are filled with boil-off gas are set to different pressures. Since the filling start pressures different from one another are set, the number of filling tanks to be filled increases when the generation amount of boil-off gas is large, and the number of filling tanks to be filled with the boil-off gas decreases when the generation amount of boil-off gas is small. In this manner, the supply pressure of the boil-off gas to the fuel cell is maintained by changing the capacity of the boil-off gas that can be filled by changing the number of filling tanks to be filled with the boil-off gas.

### SUMMARY

In a gas supply system that supplies, to a gas utilization unit, boil-off gas generated inside a storage tank in which liquefied gas is stored, a lower part of the storage tank, for example, needs to be kept at a temperature of a boiling point or less in order to maintain the liquefied gas in a liquid state inside the storage tank. In the storage tank in which a part (lower part) of the storage tank is kept at a temperature of the boiling point or less, the generation amount of boil-off gas fluctuates under the influence of the temperature of the liquefied gas stored in the storage tank.

As described above, an object of the disclosure is to provide a gas supply device that can supply gas obtained by vaporizing liquefied gas without being affected by the temperature of the liquefied gas stored in a storage tank of liquefied gas, and can suppress fluctuation of a generation amount of gas.

A gas supply device according to the disclosure includes a first pressure vessel in which liquefied gas is stored, a second pressure vessel configured to generate gas by vaporizing the liquefied gas supplied from the first pressure vessel, a liquefied gas supply path configured to allow the liquefied gas to selectively flow from the first pressure vessel toward the second pressure vessel, and a gas supply path configured to allow the gas generated in the second pressure vessel to selectively flow toward a gas utilization unit.

A gas supply method according to the disclosure is a method for supplying, to a gas utilization unit, gas obtained by vaporizing liquefied gas, the method including a first step of supplying the liquefied gas to a second pressure vessel from a first pressure vessel in which the liquefied gas is stored, and a second step of, subsequent to the first step, supplying the gas toward the gas utilization unit while generating the gas by vaporizing the liquefied gas stored in the second pressure vessel.

A gas supply method according to the disclosure is a method for supplying, to a gas utilization unit, gas obtained by vaporizing liquefied gas, the method including a first A step of supplying the liquefied gas to a second A pressure vessel from a first pressure vessel in which the liquefied gas is stored, a second A step of, subsequent to the first A step, supplying the gas toward the gas utilization unit while generating the gas by vaporizing the liquefied gas stored in the second A pressure vessel, a first B step of, while the second A step is being executed, supplying the liquefied gas from the first pressure vessel to a second B pressure vessel, and a second B step of, subsequent to the first B step, supplying the gas toward the gas utilization unit while generating the gas by vaporizing the liquefied gas stored in the second B pressure vessel.

According to the disclosure, it is possible to provide a gas supply device that can supply gas obtained by vaporizing liquefied gas without being affected by the temperature of the liquefied gas stored in a storage tank of liquefied gas, and can suppress fluctuation of a generation amount of gas.

### BRIEF DESCRIPTION OF DRAWINGS

The disclosure will be described with reference to the accompanying drawings, wherein like numbers reference like elements.

FIG. 1 is a view illustrating a gas supply device according to a first embodiment of the disclosure.

FIG. 2 is a view illustrating a control procedure of each valve by a control unit of the gas supply device according to the first embodiment of the disclosure.

FIG. 3 is a view illustrating a control procedure of each valve by the control unit of the gas supply device according to the first embodiment of the disclosure.

FIG. 4 is a view illustrating a control procedure of each valve by the control unit of the gas supply device according to the first embodiment of the disclosure.

FIG. 5 is a view illustrating a control procedure of each valve by the control unit of the gas supply device according to the first embodiment of the disclosure.

FIG. 6 is a view illustrating a gas supply device according to a second embodiment of the disclosure.

FIG. 7 is a view illustrating a control procedure of each valve by the control unit of the gas supply device according to the second embodiment of the disclosure.

FIG. 8 is a view illustrating a control procedure of each valve by the control unit of the gas supply device according to the second embodiment of the disclosure.

FIG. 9 is a view illustrating a modification of a gas supply device according to the second embodiment of the disclosure.

### DESCRIPTION OF EMBODIMENTS

Embodiments of the disclosure will be described below with reference to the accompanying drawings.

The present embodiments include at least a first embodiment and a second embodiment.

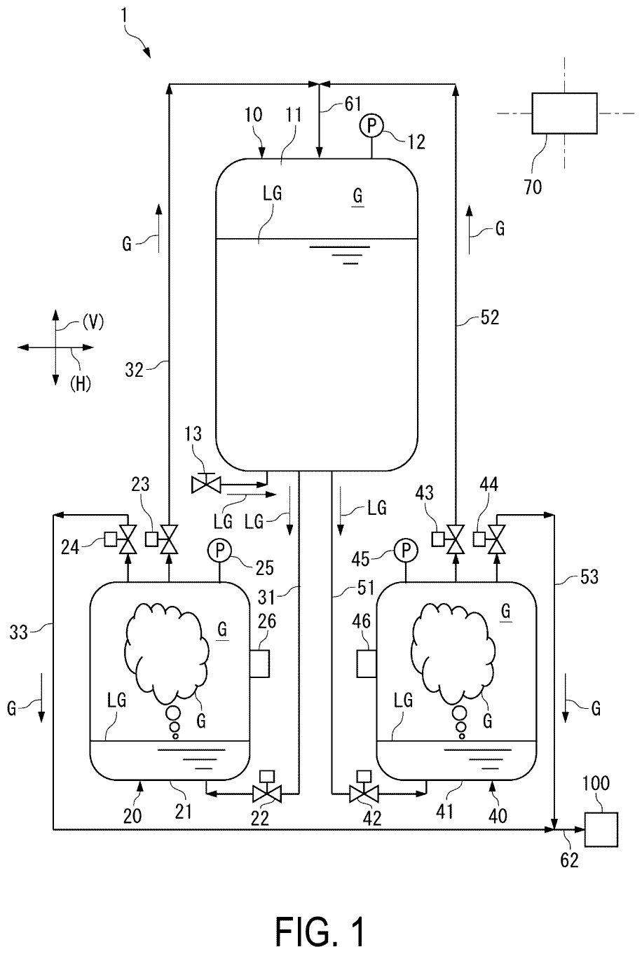

### First Embodiment: See FIGS. 1 to 5

A gas supply device 1 according to the present embodiment is, as an example, a gas supply device that supplies gas obtained by vaporizing liquefied gas to a gas utilization unit. According to this gas supply device 1, it is possible to supply gas obtained by vaporizing liquefied gas without being affected by the temperature of the liquefied gas stored in a storage tank of liquefied gas, and it is possible to suppress fluctuation of a generation amount of gas. Examples of the liquefied gas include liquid hydrogen, liquefied natural gas (LNG), and liquid ammonia.

The gas supply device 1 supplies an engine or a fuel cell of an aircraft, an unmanned aerial vehicle, or a drone, for example, with gas obtained by vaporizing liquefied gas.

### Gas Supply Device 1: See FIG. 1

As illustrated in FIG. 1, the gas supply device 1 includes a first pressure vessel 10 in which liquefied gas LG is stored and a second pressure vessel configured to generate gas G by vaporizing the liquefied gas LG supplied from the first pressure vessel 10. The gas supply device 1 includes a liquefied gas supply path configured to allow the liquefied gas LG to selectively flow from the first pressure vessel 10 toward the second pressure vessel, a vent path configured to allow the gas G generated in the second pressure vessel to selectively flow toward a gap inside the first pressure vessel 10 when the liquefied gas LG is supplied from the first pressure vessel 10 to the second pressure vessel, a gas supply path configured to allow the gas G generated in the second pressure vessel to selectively flow toward a gas utilization unit 100, and a control unit 70 configured to control operation of each device of the gas supply device 1.

The second pressure vessel includes a second A pressure vessel 20 and a second B pressure vessel 40 each connected via a liquefied gas supply path to the first pressure vessel 10 in parallel. The second A pressure vessel 20 and the second B pressure vessel 40 are connected to the gas utilization unit 100 in parallel via a gas supply path.

The liquefied gas supply path includes a first liquefied gas supply path 31 configured to allow the liquefied gas LG to selectively flow from the first pressure vessel 10 toward the second A pressure vessel 20 and a second liquefied gas supply path 51 configured to allow the liquefied gas LG to selectively flow from the first pressure vessel 10 toward the second B pressure vessel 40.

The gas supply path includes a first gas supply path 33 configured to allow the gas G generated in the second A pressure vessel 20 to selectively flow toward the gas utilization unit 100 and a second gas supply path 53 configured to allow the gas G generated in the second B pressure vessel 40 to selectively flow toward the gas utilization unit 100.

Selectively flow means that, by opening/closing a valve, the flow path allows a fluid to flow in some cases and the flow path allows no fluid to flow in other cases.

The vent path includes a first vent path 32 configured to allow the gas G generated in the second A pressure vessel 20 to selectively flow toward the gap inside the first pressure vessel 10 when the liquefied gas LG is supplied from the first pressure vessel 10 to the second A pressure vessel 20 and a second vent path 52 configured to allow the gas G generated in the second B pressure vessel 40 to selectively flow toward the gap inside the first pressure vessel 10 when the liquefied gas LG is supplied from the first pressure vessel 10 to the second B pressure vessel 40.

After merging with each other, the first vent path 32 and the second vent path 52 circulate the gas G to the first pressure vessel 10 via a merging vent path 61. Alternatively, without merging with each other, the first vent path 32 and the second vent path 52 may circulate the gas G directly to the first pressure vessel 10. After merging with each other, the first gas supply path 33 and the second gas supply path 53 circulate the gas G to the gas utili zation unit 100 via a merging gas supply path 62.

In FIG. 1 and the like, arrows illustrated between the respective pressure vessels indicate orientations in which the liquefied gas LG or the gas G circulates. In FIG. 1 and the like, a horizontal direction (H) and a vertical direction (V) are defined as illustrated. In the description of the embodiment, when an upper side or a lower side, or being high or being low is referred to, an upper side or a lower side, or being high or being low in the vertical direction (V) is referred to.

### First Pressure Vessel 10: See FIG. 1

The first pressure vessel 10 internally stores the liquefied gas LG, and alternately supplies the second A pressure vessel 20 and the second B pressure vessel 40 with the liquefied gas LG that is stored. In order to maintain the liquefied gas LG in a liquid state, the first pressure vessel 10 is subjected to heat insulating treatment for reducing heat input from the periphery of the first pressure vessel 10 to the liquefied gas LG stored in the first pressure vessel 10. Heat insulating treatment is performed by, as an example, giving the first pressure vessel a double tank structure of an inner tank and an outer tank, filling a space between the inner tank and the outer tank with a heat insulating material, and creating a vacuum between the inner tank and the outer tank. As an example, a granular heat insulating material such as pearlite, which is excellent in low-temperature heat insulation, is used as the heat insulating material.

As illustrated in FIG. 1, the first pressure vessel 10 includes: a pressure vessel body 11 that internally stores the liquefied gas LG; a first pressure detecting unit 12 that detects the pressure of the gas G inside the pressure vessel body 11; and a filling valve 13 that switches start or stop of filling of the liquefied gas LG from a liquefied gas supply source (not illustrated) in order to fill the pressure vessel body 11 with the liquefied gas LG from the outside. A liquid surface detecting unit (not illustrated) detects the storage amount of the liquefied gas LG in the pressure vessel body 11, and the control unit 70 acquires the detection result. The control unit 70 having received the detection result determines whether an upper limit filling amount or a lower limit filling amount of the liquefied gas LG to the first pressure vessel 10 has been reached. The liquefied gas LG is stored in a lower side of the pressure vessel body 11, and the gas G vaporized from the liquefied gas LG is stored in an upper side than the liquid surface of the liquefied gas LG.

The first liquefied gas supply path 31, the second liquefied gas supply path 51, and a filling path through which the liquefied gas LG fed from the filling valve 13 flows are connected to a bottom part in the vertical direction (V) of the pressure vessel body 11. The merging vent path 61 and the first pressure detecting unit 12 are connected to a top part in the vertical direction (V) of the pressure vessel body 11.

The first pressure vessel 10 is disposed at a position higher than the second A pressure vessel 20 in the vertical direction (V), and is disposed at a position higher than the second B pressure vessel 40 in the vertical direction (V). More specifically, the liquid surface of the liquefied gas LG stored in the pressure vessel body 11 may be at a position higher than the liquid surface of the liquefied gas LG after a predetermined supply amount is supplied to the second A pressure vessel 20 and the second B pressure vessel 40. With such a positional relationship, using gravity, the liquefied gas LG can be supplied to the second A pressure vessel 20 through the first liquefied gas supply path 31 connected to the bottom part of the pressure vessel body 11, and the liquefied gas LG can be supplied to the second B pressure vessel 40 through the second liquefied gas supply path 51. The supply of the liquefied gas LG from the first pressure vessel 10 may be performed by a pump provided midway in the first liquefied gas supply path 31 or midway in the second liquefied gas supply path 51.

When the liquefied gas LG is supplied to each pressure vessel, the gas G inside the second A pressure vessel 20 is fed to the first pressure vessel 10 through the first vent path 32, and the gas G inside the second B pressure vessel 40 is fed to the first pressure vessel 10 through the second vent path 52.

However, when the liquefied gas LG is supplied to the second A pressure vessel 20 and the second B pressure vessel 40, the temperature of the gas G inside the second A pressure vessel 20 and the second B pressure vessel 40 may be lowered by the liquefied gas LG that is supplied, and the gas G may be liquefied again. When such a phenomenon occurs, the gas G in the second A pressure vessel 20 and the second B pressure vessel 40 sometimes does not circulate toward the first pressure vessel 10 through the vent path. However, in order to supply the liquefied gas LG from the first pressure vessel 10 to each pressure vessel without depending on the above-described phenomenon, it is preferable to open the first vent valve 23 and the second vent valve 43.

The first pressure detecting unit 12 detects the pressure of the gas G inside the pressure vessel body 11. Specifically, the first pressure detecting unit 12 detects the pressure of mixed gas of boil-off gas generated from the liquefied gas LG inside the pressure vessel body 11 and the gas G fed to the first pressure vessel 10 through the first vent path 32 or the second vent path 52. The detection result detected by the first pressure detecting unit 12 is acquired by the control unit 70.

The filling valve 13 is closed except when the first pressure vessel 10 is filled with the liquefied gas LG. The filling valve 13 is a manual valve in the present embodiment, but may be a control valve controlled by the control unit 70.

In the present embodiment, in order to supply the gas G to the gas utilization unit 100 over a long period of time, it is desirable that the first pressure vessel 10 can store a large amount of the liquefied gas LG. Therefore, the first pressure vessel 10 is larger in capacity than the second A pressure vessel 20 and the second B pressure vessel 40. Since the first pressure vessel 10 does not actively vaporize the liquefied gas LG stored in the first pressure vessel 10, the first pressure vessel 10 is kept at a low pressure. The low pressure mentioned here is, for example, about 1 to 2 atm as gauge pressure.

The capacities of the second A pressure vessel 20 and the second B pressure vessel 40 are small in order to increase, to a high pressure, the pressure of the gas G obtained by vaporizing a small amount of the liquefied gas LG supplied from the first pressure vessel 10. The high pressure mentioned here is, for example, about 10 to 50 atm as gauge pressure.

### Second A Pressure Vessel 20: See FIG. 1

The second A pressure vessel 20 vaporizes the liquefied gas LG supplied from the first pressure vessel 10, and supplies the gas G after vaporization to the gas utilization unit 100. The second A pressure vessel 20 is subjected to heat insulating treatment similar to that of the first pressure vessel 10 for reducing heat input to the second A pressure vessel 20 so that the liquefied gas LG supplied from the first pressure vessel 10 is maintained in a liquid state. However, unlike the first pressure vessel 10, heat can be input to the second A pressure vessel 20 in order to vaporize the liquefied gas LG.

As illustrated in FIG. 1, the second A pressure vessel 20 includes a pressure vessel body 21 that vaporizes the liquefied gas LG supplied from the first pressure vessel 10 via the first liquefied gas supply path 31. The liquid surface detecting unit (not illustrated) detects the storage amount of the liquefied gas LG in the pressure vessel body 21, and the control unit 70 acquires the detection result. The control unit 70 having received the detection result determines whether the supply amount of the liquefied gas LG to the second A pressure vessel 20 has reached a predetermined supply amount and whether the liquefied gas LG has been entirely vaporized.

Furthermore, the second A pressure vessel 20 includes a first liquefied gas supply valve 22 provided midway in the first liquefied gas supply path 31 and configured to switch between start and stop of supply of the liquefied gas LG supplied from the first pressure vessel 10, a first vent valve 23 provided midway in the first vent path 32 and configured to switch between start and stop of circulation of the gas G to the first pressure vessel 10, and a first gas supply valve 24 provided midway in the first gas supply path 33 and configured to switch between start and stop of supply of the gas G to the gas utilization unit 100.

The second A pressure vessel 20 includes a second pressure detecting unit 25 that detects the pressure of the gas G inside the pressure vessel body 21 and a first heat input unit 26 that inputs heat to the pressure vessel body 21.

The pressure vessel body 21 stores the liquefied gas LG supplied from the first pressure vessel 10. The gas G vaporized from the liquefied gas LG is stored in an upper side than the liquid surface of the liquefied gas LG of the pressure vessel body 21.

The first liquefied gas supply path 31 is connected to a bottom part of the pressure vessel body 21. The first vent path 32, the first gas supply path 33, and the second pressure detecting unit 25 are connected to a top part of the pressure vessel body 21. A trunk part of the pressure vessel body 21 is provided with the first heat input unit 26.

The first liquefied gas supply valve 22 is a control valve controlled by the control unit 70 in the present embodiment. When supply of the liquefied gas LG from the first pressure vessel 10 to the second A pressure vessel 20 is started, the first liquefied gas supply valve 22 is opened by the control unit 70. When supply of the liquefied gas LG from the first pressure vessel 10 to the second A pressure vessel 20 is stopped, the first liquefied gas supply valve 22 is closed by the control unit 70.

The first vent valve 23 is a control valve controlled by the control unit 70 in the present embodiment. The first liquefied gas supply valve 22 is opened by the control unit 70, and the first vent valve 23 is opened by the control unit 70. The first liquefied gas supply valve 22 is closed by the control unit 70, and the first vent valve 23 is closed by the control unit 70.

That is, the first liquefied gas supply valve 22 and the first vent valve 23 are opened when supply of the liquefied gas LG from the first pressure vessel 10 to the second A pressure vessel 20 is started, and are closed when the supply is stopped.

The first gas supply valve 24 is a control valve controlled by the control unit 70 in the present embodiment. The first liquefied gas supply valve 22 and the first vent valve 23 are opened by the control unit 70, and the first gas supply valve 24 is closed by the control unit 70. The first liquefied gas supply valve 22 and the first vent valve 23 are closed by the control unit 70, and the first gas supply valve 24 is opened by the control unit 70.

When the first gas supply valve 24 is opened, supply of the gas G vaporized from the liquefied gas LG in the pressure vessel body 21 to the gas utilization unit 100 is started, and when the first gas supply valve 24 is closed, the supply of the gas G to the gas utilization unit 100 is stopped. The gas Gis supplied to the gas utilization unit 100 through the first gas supply path 33 and the merging gas supply path 62. Note that the gas G may be circulated directly to the gas utilization unit 100 without merging to the merging gas supply path 62.

The second pressure detecting unit 25 detects the pressure inside the pressure vessel body 21. Specifically, the pressure of the gas G vaporized from the liquefied gas LG in the pressure vessel body 21 is detected. The detection result detected by the second pressure detecting unit 25 is acquired by the control unit 70.

By inputting heat to the pressure vessel body 21, the first heat input unit 26 can increase the generation amount of the gas G vaporized from the liquefied gas LG inside the pressure vessel body 21. In general, the liquefied gas is kept in a liquid state by being maintained at a temperature far below zero degrees Celsius. For example, the liquid state is kept at minus 253 degrees Celsius or less for liquid hydrogen, minus 162 degrees Celsius or less for liquefied natural gas (LNG), and minus 33 degrees Celsius or less for liquid ammonia. When an object having a temperature of, for example, about 27 degrees Celsius is brought into contact with the pressure vessel body 21 in which the liquefied gas LG is stored, the heat input amount to the pressure vessel body 21 becomes very large, and the generation amount of the gas G can be increased.

The first heat input unit 26 is, for example, a metal body made of copper or aluminum, and can be brought into contact with and separated from the pressure vessel body 21 by a drive source (not illustrated). Copper or aluminum is used as a metal body because a metal having high thermal conductivity is required in order to increase the heat input amount from the first heat input unit 26 to the pressure vessel body 21. Heat is input when the metal body constituting the first heat input unit 26 is brought into contact with the pressure vessel body 21, and heat input is stopped when the metal body constituting the first heat input unit 26 is separated from the pressure vessel body 21.

The pressure vessel body 21 may have a double tank structure in which the space between the inner tank and the outer tank is in a vacuum state. The first heat input unit 26 in this case may input heat to the pressure vessel body 21 by allowing carbon dioxide in a gaseous state to selectively circulate between the inner tank and the outer tank. A space between the inner tank and the outer tank through which carbon dioxide in a gaseous state flows is referred to as a carbon dioxide circulation path. When heat input by the first heat input unit 26 is started, carbon dioxide in a gaseous state at a temperature exceeding the freezing point flows through the carbon dioxide circulation path. Heat is input by transferring heat energy from the carbon dioxide circulating through the carbon dioxide circulation path to the liquefied gas LG stored in the inner tank. When the heat input of the first heat input unit 26 is stopped, the circulation of the carbon dioxide is stopped, and the carbon dioxide in a gaseous state retaining in the carbon dioxide circulation path is cooled and solidified by the liquefied gas LG supplied to the pressure vessel body 21. Since the carbon dioxide in a gaseous state retaining midway in the carbon dioxide circulation path is solidified and the volume contracts, the vacuum state is restored. When the heat input from the first heat input unit 26 is stopped, the space between the inner tank and the outer tank of the pressure vessel body 21 is brought into a vacuum state, and therefore a vacuum heat insulating effect can be maintained. When the heat input from the first heat input unit 26 is started again, carbon dioxide in a gaseous state at a temperature exceeding the freezing point flows through the carbon dioxide circulation path, and thus solidified carbon dioxide is heated and vaporized midway in the carbon dioxide circulation path. The carbon dioxide circulating through the carbon dioxide circulation path repeats solidification and vaporization, and therefore clogging of the carbon dioxide circulation path can be prevented.

The generation amount per unit time of the gas G obtained by vaporizing the liquefied gas LG stored in the first pressure vessel 10 fluctuates because it is affected by the temperature of the liquefied gas LG itself. The generation amount of the gas G per unit time is small. However, by inputting heat from the first heat input unit 26 to the liquefied gas LG transferred to the second A pressure vessel 20, it is possible to suppress fluctuation in the generation amount of the gas G and to increase the generation amount of the gas G per unit time.

Since the generation amount of the gas G per unit time can be increased, the pressure of the gas G supplied to the gas utilization unit 100 can be maintained at a high pressure.

Note that although the pressure gas G at high pressure is supplied from the second A pressure vessel 20 directly to the gas utilization unit 100, the gas G may be supplied from the second A pressure vessel 20 to another large-capacity vessel, and the pressure gas G at high pressure may be supplied from the large-capacity vessel in which the gas G is stored to the gas utilization unit 100.

### Second B Pressure Vessel 40: See FIG. 1

Similarly to the second A pressure vessel 20, the second B pressure vessel 40 vaporizes the liquefied gas LG supplied from the first pressure vessel 10, and supplies the gas G after vaporization to the gas utilization unit 100. The second B pressure vessel 40 is subjected to heat insulating treatment similar to that of the first pressure vessel 10 for reducing heat input to the second B pressure vessel 40 so that the liquefied gas LG supplied from the first pressure vessel 10 is maintained in a liquid state. However, unlike the first pressure vessel 10, heat can be input to the second B pressure vessel 40 in order to vaporize the liquefied gas LG.

As illustrated in FIG. 1, the second B pressure vessel 40 includes a pressure vessel body 41 that vaporizes the liquefied gas LG supplied from the first pressure vessel 10 via the second liquefied gas supply path 51. The liquid surface detecting unit (not illustrated) detects the storage amount of the liquefied gas LG in the pressure vessel body 41, and the control unit 70 acquires the detection result. The control unit 70 having received the detection result determines whether the supply amount of the liquefied gas LG to the second B pressure vessel 40 has reached a predetermined supply amount and whether the liquefied gas LG has been entirely vaporized.

Furthermore, the second B pressure vessel 40 includes a second liquefied gas supply valve 42 provided midway in the second liquefied gas supply path 51 and configured to switch between start and stop of supply of the liquefied gas LG supplied from the first pressure vessel 10, a second vent valve 43 provided midway in the second vent path 52 and configured to switch between start and stop of circulation of the gas G to the first pressure vessel 10, and a second gas supply valve 44 provided midway in the second gas supply path 53 and configured to switch between start and stop of supply of the gas G to the gas utilization unit 100.

The second B pressure vessel 40 includes a third pressure detecting unit 45 that detects the pressure of the gas G inside the pressure vessel body 41 and a second heat input unit 46 that inputs heat to the pressure vessel body 41.

The pressure vessel body 41 stores the liquefied gas LG supplied from the first pressure vessel 10. The gas G vaporized from the liquefied gas LG is stored in an upper side than the liquid surface of the liquefied gas LG of the pressure vessel body 41.

The second liquefied gas supply path 51 is connected to a bottom part of the pressure vessel body 41. The second vent path 52, the second gas supply path 53, and the third pressure detecting unit 45 are connected to a top part of the pressure vessel body 41. A trunk part of the pressure vessel body 41 is provided with the second heat input unit 46.

The second liquefied gas supply valve 42 is a control valve controlled by the control unit 70 in the present embodiment. When supply of the liquefied gas LG from the first pressure vessel 10 to the second B pressure vessel 40 is started, the second liquefied gas supply valve 42 is opened by the control unit 70. When supply of the liquefied gas LG from the first pressure vessel 10 to the second B pressure vessel 40 is stopped, the second liquefied gas supply valve 42 is closed by the control unit 70.

The second vent valve 43 is a control valve controlled by the control unit 70 in the present embodiment. The second liquefied gas supply valve 42 is opened by the control unit 70, and the second vent valve 43 is opened by the control unit 70. The second liquefied gas supply valve 42 is closed by the control unit 70, and the second vent valve 43 is closed by the control unit 70.

That is, the second liquefied gas supply valve 42 and the second vent valve 43 are opened when supply of the liquefied gas LG from the first pressure vessel 10 to the second B pressure vessel 40 is started, and are closed when the supply is stopped.

The second gas supply valve 44 is a control valve controlled by the control unit 70 in the present embodiment. The second liquefied gas supply valve 42 and the second vent valve 43 are opened by the control unit 70, and the second gas supply valve 44 is closed by the control unit 70. The second liquefied gas supply valve 42 and the second vent valve 43 are closed by the control unit 70, and the second gas supply valve 44 is opened by the control unit 70.

When the second gas supply valve 44 is opened, supply of the gas G vaporized from the liquefied gas LG in the pressure vessel body 41 to the gas utilization unit 100 is started, and when the second gas supply valve 44 is closed, the supply of the gas G to the gas utilization unit 100 is stopped. The gas G is supplied to the gas utilization unit 100 through the second gas supply path 53 and the merging gas supply path 62.

The third pressure detecting unit 45 detects the pressure inside the pressure vessel body 41. Specifically, the pressure of the gas G vaporized from the liquefied gas LG in the pressure vessel body 41 is detected. The detection result detected by the third pressure detecting unit 45 is acquired by the control unit 70.

By inputting heat to the pressure vessel body 41, the second heat input unit 46 can increase the generation amount of the gas G vaporized from the liquefied gas LG inside the pressure vessel body 41. In general, the liquefied gas is kept in a liquid state by being maintained at a temperature far below zero degrees Celsius. For example, when an object having a temperature of about 27 degrees Celsius as an outside air temperature is brought into contact with the pressure vessel body 41, the heat input amount to the pressure vessel body 41 becomes very large, and the generation amount of the gas G can be increased.

Similarly to the first heat input unit 26, the second heat input unit 46 is, for example, a metal body made of copper or aluminum, and is configured to be able to be brought into contact with and separated from the pressure vessel body 41 by a drive source (not illustrated). Heat input is started when the metal body constituting the second heat input unit 46 is brought into contact with the pressure vessel body 41, and heat input is stopped when the metal body constituting the second heat input unit 46 is separated from the pressure vessel body 41.

Similarly to the pressure vessel body 21, the pressure vessel body 41 may have a double tank structure in which the space between the inner tank and the outer tank is in a vacuum state. The second heat input unit 46 in this case may input heat to the pressure vessel body 41 by allowing carbon dioxide in a gaseous state to selectively circulate between the inner tank and the outer tank. A space between the inner tank and the outer tank through which carbon dioxide in a gaseous state flows is referred to as a carbon dioxide circulation path. When heat input by the second heat input unit 46 is started, circulation of carbon dioxide into the carbon dioxide circulation path is started. When heat input by the second heat input unit 46 is stopped, circulation of carbon dioxide in the carbon dioxide circulation path is stopped. When the heat input of the second heat input unit 46 is stopped, the carbon dioxide in a gaseous state retaining midway in the carbon dioxide circulation path is cooled and solidified by the liquefied gas LG supplied to the pressure vessel body 41. Since the carbon dioxide in a gaseous state retaining midway in the carbon dioxide circulation path is solidified and the volume contracts, the vacuum insulation is restored. When the heat input from the second heat input unit 46 is stopped, the space between the inner tank and the outer tank of the pressure vessel body 41 is brought into a vacuum state, and therefore a vacuum heat insulating effect can be maintained.

The generation amount per unit time of the gas G obtained by vaporizing the liquefied gas LG stored in the first pressure vessel 10 fluctuates because it is affected by the temperature of the liquefied gas LG itself. The generation amount of the gas G per unit time is small. However, by inputting heat from the second heat input unit 46 to the liquefied gas LG transferred to the second B pressure vessel 40, it is possible to suppress fluctuation in the generation amount of the gas G and to increase the generation amount of the gas G per unit time.

Since the generation amount of the gas G per unit time can be increased, the pressure of the gas G supplied to the gas utilization unit 100 can be maintained at a high pressure.

Note that although the pressure gas G at high pressure is supplied from the second B pressure vessel 40 directly to the gas utilization unit 100, the gas G may be supplied from the second B pressure vessel 40 to another large-capacity vessel, and the pressure gas G at high pressure may be supplied from the large-capacity vessel in which the gas G is stored to the gas utilization unit 100.

### Control Unit 70: See FIG. 1

The control unit 70 controls the operation of each device of the gas supply device 1.

The control unit 70 controls switching of opening/closing of each of the first liquefied gas supply valve 22, the second liquefied gas supply valve 42, the first vent valve 23, the second vent valve 43, the first gas supply valve 24, and the second gas supply valve 44. The control unit 70 receives detection results of the first pressure detecting unit 12, the second pressure detecting unit 25, and the third pressure detecting unit 45. The control unit 70 may control switching of opening/closing of each valve based on detection results of the first pressure detecting unit 12, the second pressure detecting unit 25, and the third pressure detecting unit 45.

The control unit 70 includes an output unit (not illustrated) that issues, to the worker, an alarm regarding the state of the gas supply device 1. For example, the output unit issues, to the worker, an alarm that the upper limit filling amount of the liquefied gas LG in the first pressure vessel 10 has been reached.

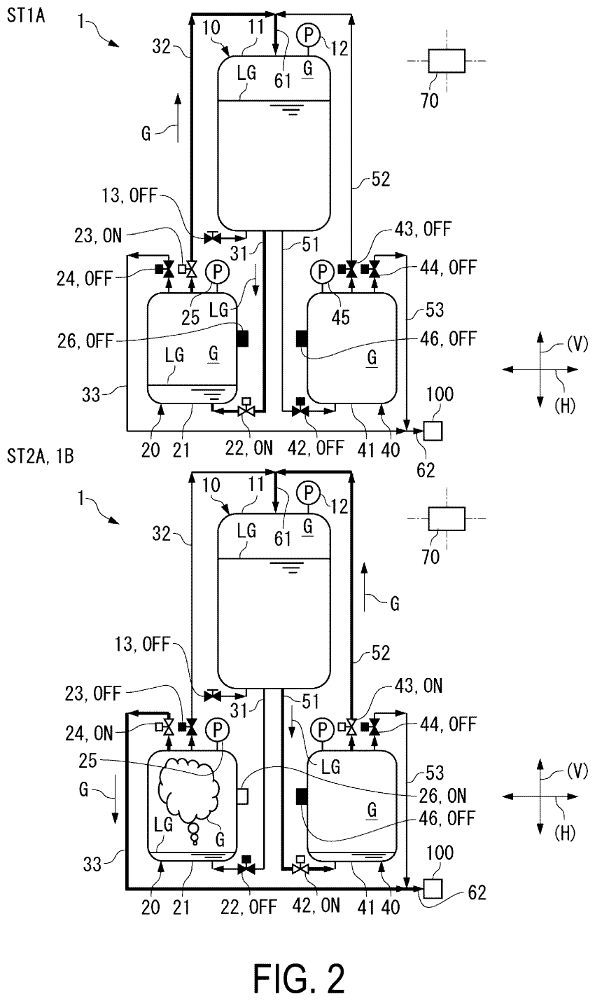

### Gas Generation and Supply Procedure: See FIGS. 2 to 5

Hereinafter, a generating and supplying procedure of the gas G in the gas supply device 1 will be described with reference to FIGS. 2 to 5.

Note that the generating and supplying procedure of the gas G described below is performed in accordance with an instruction from the control unit 70. Before this procedure is started, inside of the first pressure vessel 10, the second A pressure vessel 20, and the second B pressure vessel 40 is replaced with the gas G obtained by vaporizing the liquefied gas LG, for example. In addition, inside of the first pressure vessel 10, the second A pressure vessel 20, and the second B pressure vessel 40 may be in a state of medium vacuum (JIS Z 8126-1) of less than 100 Pa and 0.1 Pa or more. It is assumed that before the procedure is started, the first pressure vessel 10 is filled with the liquefied gas LG and all the valves are closed.

In the drawings, a state in which the valve is opened is in white and “ON” is written together with the reference sign, a state in which the valve is closed is in black and “OFF” is written together with the reference sign. The heat input states of the first heat input unit 26 and the second heat input unit 46 are in white and “ON” is written together with the reference sign, the heat input stop state is in black and “OFF” is written together with the reference sign.

In the procedure, supply (first A step) of the liquefied gas LG from the first pressure vessel 10 to the second A pressure vessel 20 and supply (second A step) of the liquefied gas LG from the first pressure vessel 10 to the second B pressure vessel 40 are alternately repeated. In the procedure, supply (second B step) of the gas G from the second B pressure vessel 20 to the gas utilization unit 100 while the liquefied gas LG is supplied to the second A pressure vessel 40, and supply (first B step) of the gas G from the second A pressure vessel 40 to the gas utilization unit 100 while the liquefied gas LG is supplied to the second B pressure vessel 20 are alternately repeated. That is, the liquefied gas LG is alternately supplied to the two pressure vessels 20 and 40, and during supply of the liquefied gas LG to one pressure vessel, the gas G is supplied from the other pressure vessel to the gas utilization unit 100. In this manner, it is possible to continuously supply the gas by alternately supplying the liquefied gas LG to the two pressure vessels 20 and 40 and alternately switching supply from the pressure vessel not supplied with the liquefied gas LG to the gas utilization unit 100.

### First A Step: See ST1A in FIG. 2

In the first A step, the first liquefied gas supply valve 22 and the first vent valve 23 are opened. Due to this, the liquefied gas LG is supplied from the first pressure vessel 10 to the second A pressure vessel 20 via the first liquefied gas supply path 31, and the gas G stored in the second A pressure vessel 20 is circulated to the first pressure vessel 10 via the first vent path 32.

Note that the opening/closing state of the valve is summarized below.
Open (ON): first liquefied gas supply valve 22, first vent valve 23
   Close (OFF): first gas supply valve 24, second liquefied gas supply valve 42, second vent valve 43, second gas supply valve 44, filling valve 13

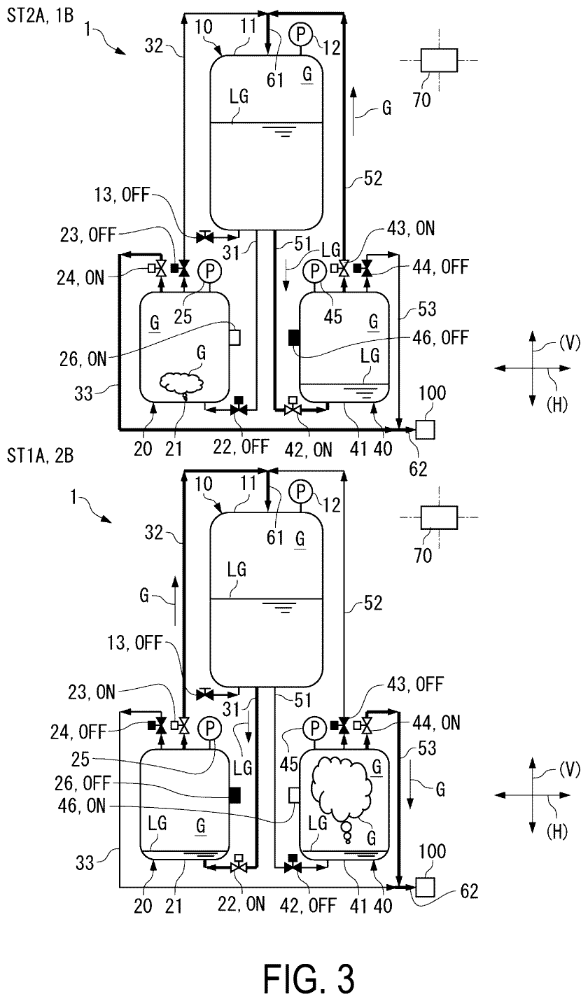

### Second a Step and First B Step: See ST2A in FIG. 2 and STIB in FIG. 3

Subsequent to the first A step, the second A step and the first B step are executed.

In the second A step, the first liquefied gas supply valve 22 and the first vent valve 23 are closed. Due to this, the supply of the liquefied gas from the first pressure vessel 10 to the second A pressure vessel 20 is stopped, and the supply of the gas G to the first pressure vessel 10 via the first vent path 32 is also stopped.

In the second A step, the liquefied gas LG stored in the second A pressure vessel 20 is vaporized by inputting heat from the first heat input unit 26.

In the second A step, by opening of the first gas supply valve 24, the gas G is supplied from the second A pressure vessel 20 to the gas utilization unit 100 via the first gas supply path 33 and the merging gas supply path 62. Note that the first gas supply valve 24 may be opened based on the detection result of the second pressure detecting unit 25. The first gas supply valve 24 may be opened, for example, after the pressure of the gas G detected by the second pressure detecting unit 25 reaches the pressure required for the gas utilization unit 100. By the opening of the first gas supply valve 24, the gas G is supplied to the gas utilization unit 100.

In the first B step, the second liquefied gas supply valve 42 and the second vent valve 43 are opened. Due to this, the liquefied gas LG is supplied from the first pressure vessel 10 to the second B pressure vessel 40 via the second liquefied gas supply path 51, and the gas G stored in the second B pressure vessel 40 is circulated to the first pressure vessel 10 via the second vent path 52.

Note that the opening/closing states of the valves in the second A step and the first B step are summarized below.
Open (ON): first gas supply valve 24, second liquefied gas supply valve 42, second vent valve 43
Close (OFF): first liquefied gas supply valve 22, first vent valve 23, second gas supply valve 44, filling valve 13

In the first B step, as illustrated in STIB in FIG. 3, as an example, the supply of the gas G to the gas utilization unit 100 is continued until the liquefied gas LG stored in the second A pressure vessel 20 is entirely vaporized. Note that the supply of the gas G to the gas utilization unit 100 may be continued until the pressure of the gas G detected by the second pressure detecting unit 25 can maintain the required pressure of the gas utilization unit 100. While the supply of the gas G from the second A pressure vessel 20 to the gas utilization unit 100 continues, the supply of the liquefied gas LG to the second B pressure vessel 40 is completed.

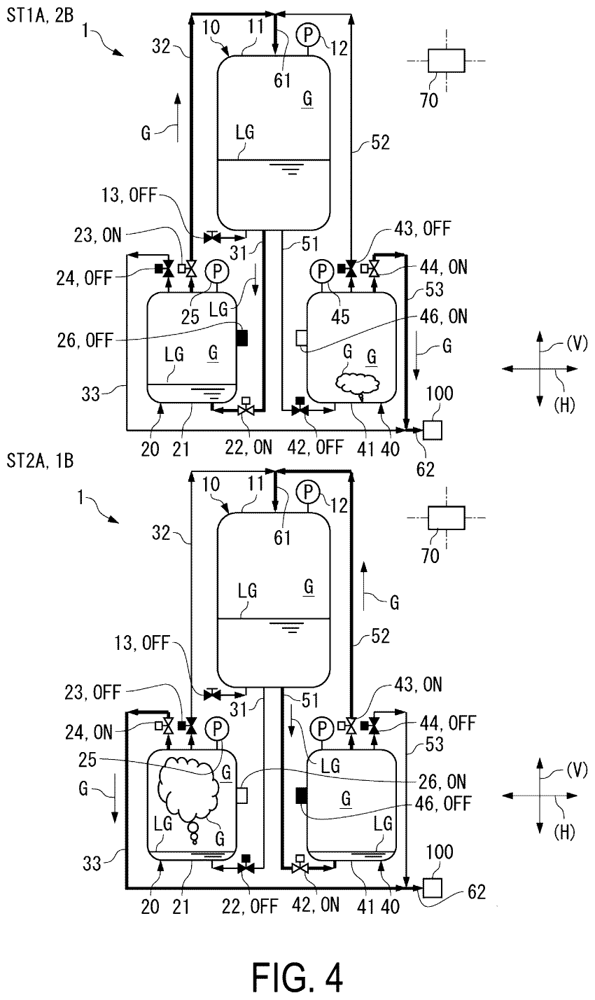

### First A Step and Second B Step: See ST1A in FIG. 3 and ST2B in FIG. 4

Subsequent to the second A step and the first B step, the first A step and the second B step are executed.

In the first A step, when the first gas supply valve 24 is closed, supply of the gas G from the second A pressure vessel 20 to the gas utilization unit 100 is stopped. Heat input from the first heat input unit 26 is stopped. The supply of the gas G to the gas utilization unit 100 is stopped, and the first liquefied gas supply valve 22 and the first vent valve 23 are opened. Due to this, the liquefied gas LG is supplied from the first pressure vessel 10 to the second A pressure vessel 20 via the first liquefied gas supply path 31. By the opening of the first vent valve 23, the gas G stored in the second A pressure vessel 20 is circulated to the first pressure vessel 10 via the first vent path 32.

In the second B step, when the second liquefied gas supply valve 42 and the second vent valve 43 are closed, supply of the liquefied gas from the first pressure vessel 10 to the second B pressure vessel 40 is stopped. The liquefied gas LG stored in the second B pressure vessel 40 is vaporized by inputting heat from the second heat input unit 46.

In the second B step, by the opening of the second gas supply valve 44, supply of the gas G from the second B pressure vessel 40 to the gas utilization unit 100 is started. Note that the second gas supply valve 44 may be opened based on the detection result of the third pressure detecting unit 45. The second gas supply valve 44 may be opened, for example, after the pressure of the gas G detected by the third pressure detecting unit 45 reaches the pressure required for the gas utilization unit 100. By the opening of the second gas supply valve 44, the gas G is supplied to the gas utilization unit 100.

Note that the opening/closing states of the valves in the first A step and the second B step are summarized below.
Open (ON): second gas supply valve 44, first liquefied gas supply valve 22, first vent valve 23
Close (OFF): second liquefied gas supply valve 42, second vent valve 43, first gas supply valve 24, filling valve 13

In the second B step, as illustrated in ST2B in FIG. 4, as an example, the supply of the gas G to the gas utilization unit 100 is continued until the liquefied gas LG stored in the second B pressure vessel 40 is entirely vaporized. Note that the supply of the gas G to the gas utilization unit 100 may be continued until the pressure of the gas G detected by the third pressure detecting unit 45 can maintain the required pressure of the gas utilization unit 100. While the supply of the gas G from the second B pressure vessel 40 to the gas utilization unit 100 continues, the supply of the liquefied gas LG to the second A pressure vessel 20 is completed.

### Second A Step and First B Step: See ST2A in FIG. 4 and STIB in FIG. 4

Subsequent to the first A step and the second B step, the second A step and the first B step are executed.

In the second A step, the first liquefied gas supply valve 22 and the first vent valve 23 are closed. Due to this, the supply of the liquefied gas from the first pressure vessel 10 to the second A pressure vessel 20 is stopped, and the supply of the gas G to the first pressure vessel 10 via the first vent path 32 is also stopped. Heat input by the first heat input unit 26 is started, and vaporization of the liquefied gas LG stored in the second A pressure vessel 20 is started.

In the second A step, by opening of the first gas supply valve 24, the gas G is supplied from the second A pressure vessel 20 to the gas utilization unit 100. Note that the first gas supply valve 24 may be opened based on the detection result of the second pressure detecting unit 25. Similarly to the description in ST1A in FIG. 2, the first gas supply valve 24 may be opened, for example, after the pressure of the gas G detected by the second pressure detecting unit 25 reaches the pressure required for the gas utilization unit 100. By the opening of the first gas supply valve 24, the gas G is supplied to the gas utilization unit 100.

In the first B step, the second liquefied gas supply valve 42 and the second vent valve 43 are opened. Due to this, the liquefied gas LG is supplied from the first pressure vessel 10 to the second B pressure vessel 40 via the second liquefied gas supply path 51, and the gas G stored in the second B pressure vessel 40 is circulated to the first pressure vessel 10 via the second vent path 52.

Note that the opening/closing states of the valves in the second A step and the first B step are summarized below.
Open (ON): first gas supply valve 24, second liquefied gas supply valve 42, second vent valve 43
Close (OFF): first liquefied gas supply valve 22, first vent valve 23, second gas supply valve 44, filling valve 13

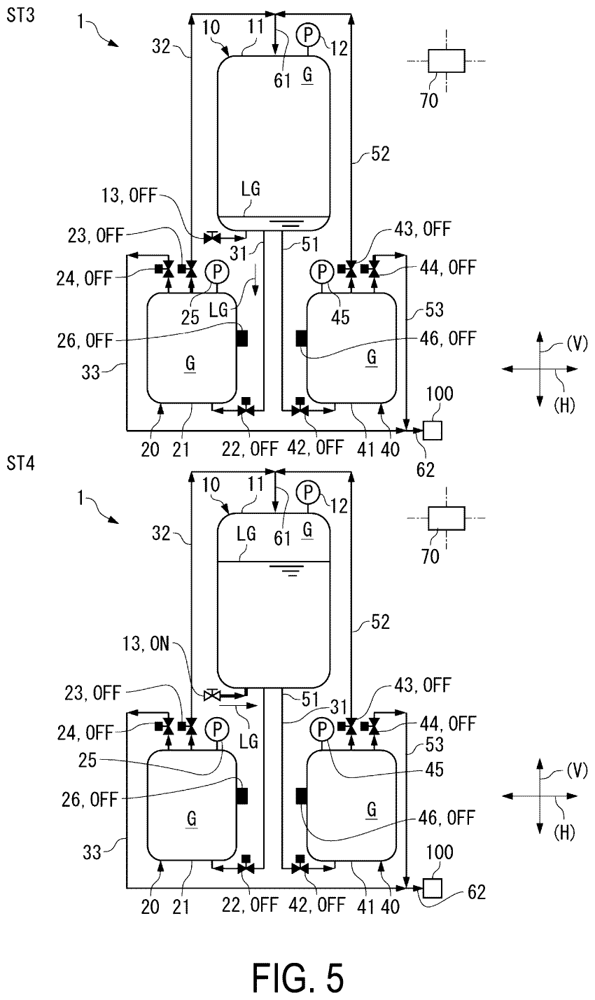

### Third Step: See ST3 in FIG. 5

When the liquefied gas LG stored in the first pressure vessel 10 has the lower limit filling amount or less, subsequent to the first A step and the second B step, or subsequent to the second A step and the first B step, the third step is executed.

In the third step, after the liquefied gas LG inside the second A pressure vessel 20 is entirely vaporized in the second A step, the first gas supply valve 24, the second liquefied gas supply valve 42, and the second vent valve 43 are closed. Due to this, the supply of the liquefied gas LG to the second B pressure vessel 40 is stopped, and the supply of the gas G from the second A pressure vessel 20 to the gas utilization unit 100 is stopped.

Alternatively, in the third step, after the liquefied gas LG inside the second B pressure vessel 40 is entirely vaporized in the second B step, the second gas supply valve 44, the first liquefied gas supply valve 22, and the first vent valve 23 are closed. Due to this, the supply of the liquefied gas LG to the second A pressure vessel 20 is stopped, and the supply of the gas G from the second B pressure vessel 40 to the gas utilization unit 100 is stopped.

Note that whether the liquefied gas LG has the lower limit filling amount or less is determined by the control unit 70 having received the detection result detected by the liquid surface detecting unit (not illustrated).

Note that the opening/closing state of the valve in the third step is summarized below.
Open (ON): none
Closing (OFF): first liquefied gas supply valve 22, first vent valve 23, first gas supply valve 24, second liquefied gas supply valve 42, second vent valve 43, second gas supply valve 44, filling valve 13

### Fourth Step: See ST4 in FIG. 5

Subsequent to the third step, the fourth step is executed.

In the fourth step, the filling valve 13 connected to the supply source (not illustrated) of the liquefied gas LG is opened by the worker, thereby starting filling of the liquefied gas LG into the first pressure vessel 10. When the liquefied gas LG in the first pressure vessel 10 reaches the upper limit filling amount, the filling valve 13 is closed by the worker to stop the filling of the liquefied gas LG into the first pressure vessel 10. Note that whether the filling amount has reached the upper limit filling amount is determined by the control unit 70 having received the detection result detected by the liquid surface detecting unit (not illustrated), and when the filling amount of the liquefied gas LG has reached the upper limit filling amount, an output unit included in the control unit 70 issues an alarm to the worker.

After the filling of the liquefied gas LG into the first pressure vessel 10 is completed, the supply of the liquefied gas LG to the second A pressure vessel 20 and the second B pressure vessel 40 is alternately resumed, and the supply of the gas G from the second A pressure vessel 20 and the second B pressure vessel 40 into the gas utilization unit 100 is alternately resumed.

### Effects

The gas supply device 1 according to the present embodiment described above achieves the following effects.

### First Effect

The gas supply device 1 vaporizes the liquefied gas LG transferred to the second A pressure vessel 20 and the second B pressure vessel 40, which are pressure vessels different from the first pressure vessel 10 storing the liquefied gas LG maintained at a low temperature. The gas supply device 1 can supply the gas obtained by vaporizing the liquefied gas without being affected by the temperature of the liquefied gas LG stored in the first pressure vessel 10, and can suppress fluctuation of the generation amount of the gas.

### Second Effect

Furthermore, by closing the first liquefied gas supply valve 22 and the first vent valve 23, it is possible to bring the second A pressure vessel 20 in which the gas G having a high pressure after vaporization of the liquefied gas LG is stored and the first pressure vessel 10 into a non-communicating state, and therefore it is possible to prevent backflow of the gas G at high pressure into the first pressure vessel 10 in which the liquefied gas LG is stored. By closing the second liquefied gas supply valve 42 and the second vent valve 43, it is possible to bring the second B pressure vessel 40 in which the gas G having a high pressure after vaporization of the liquefied gas LG is stored and the first pressure vessel 10 into a non-communicating state, and therefore it is possible to prevent backflow of the gas G at high pressure into the first pressure vessel 10 in which the liquefied gas LG is stored.

### Third Effect

The supply of the liquefied gas LG from the first pressure vessel 10 to the second A pressure vessel 20 and the supply of the liquefied gas LG from the first pressure vessel 10 to the second B pressure vessel 40 are alternately repeated, and the supply of the gas G from the second B pressure vessel 40 to the gas utilization unit 100 when the liquefied gas LG is supplied to the second A pressure vessel 20 and the supply of the gas G from the second A pressure vessel 20 to the gas utilization unit 100 when the liquefied gas LG is supplied to the second B pressure vessel 40 are alternately repeated. It is possible to continuously supply the gas by alternately supplying the liquefied gas LG to the two pressure vessels 20 and 40 and alternately switching supply from the pressure vessel not supplied with the liquefied gas LG to the gas utilization unit 100.

### Fourth Effect

In the gas supply device 1, the second A pressure vessel 20 includes the first heat input unit 26 that inputs heat to the second A pressure vessel 20, and the second B pressure vessel 40 includes the second heat input unit 46 that inputs heat to the second B pressure vessel 40.

According to the gas supply device 1, it is possible to increase the generation amount of the gas G per unit time by promoting vaporization of the liquefied gas LG by heat input in the second A pressure vessel 20 and the second B pressure vessel 40 different from the first pressure vessel 10 in which the liquefied gas LG is stored.

### Fifth Effect

In the gas supply device 1, the first pressure vessel 10 is disposed at a position higher than the second A pressure vessel 20 in the vertical direction (V), and the first pressure vessel 10 is disposed at a position higher than the second B pressure vessel 40 in the vertical direction (V). With such an arrangement, using gravity, the liquefied gas LG can be supplied to the second A pressure vessel 20 through the first liquefied gas supply path 31 connected to the first pressure vessel 10, and the liquefied gas LG can be supplied to the second B pressure vessel 40 through the second liquefied gas supply path 51 connected to the first pressure vessel 10.

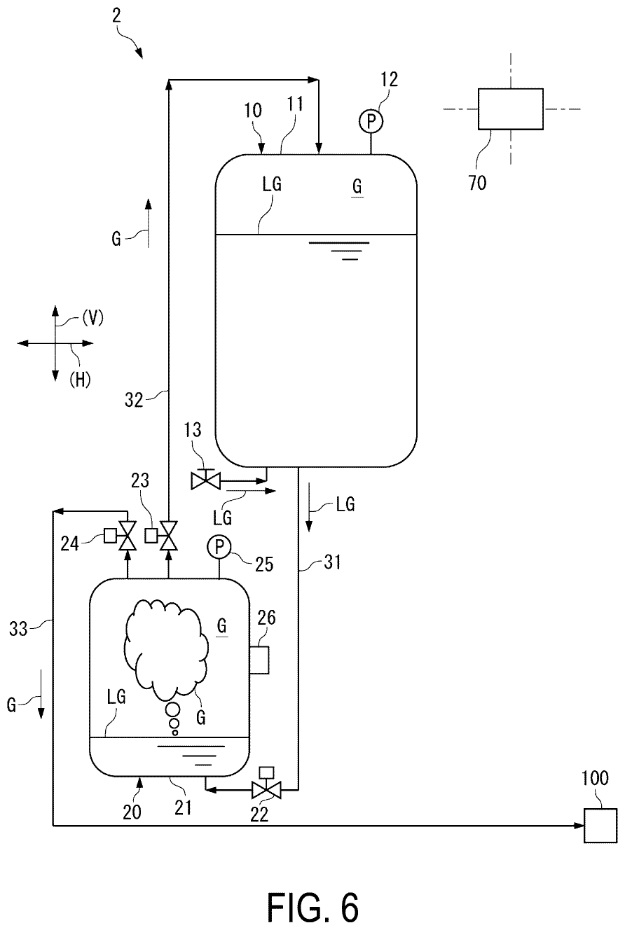

### Second Embodiment: See FIGS. 6 to 9

The gas supply device 2 according to the present embodiment is different in not including the second B pressure vessel 40 of the gas supply device 1 of the first embodiment. Since the gas supply device 1 of the first embodiment includes the second A pressure vessel 20 and the second B pressure vessel 40, the gas supply device 1 can continuously supply the gas G to the gas utilization unit 100 until the liquefied gas LG inside the first pressure vessel 10 reaches the lower limit storage amount. However, since the gas supply device 2 of the second embodiment does not include the second B pressure vessel 40, the gas G can be intermittently supplied to the gas utilization unit 100 until the liquefied gas LG inside the first pressure vessel 10 reaches the lower limit storage amount. In FIG. 6 and the like, the same elements as those in the first embodiment are denoted by the same reference signs as those in FIG. 1, and a detailed description thereof will be omitted.

The gas supply device 2 according to the present embodiment can also supply the gas utilization unit 100 with the gas obtained by vaporizing the liquefied gas without being affected by the temperature of the liquefied gas LG stored in the first pressure vessel 10, and can also suppress fluctuation of the generation amount of the gas.

### Gas Supply Device 2: See FIG. 6

The gas supply device 2 includes the first pressure vessel 10 in which the liquefied gas LG is stored, the second pressure vessel 20 configured to generate gas G by vaporizing the liquefied gas LG supplied from the first pressure vessel 10, a liquefied gas supply path 31 configured to allow the liquefied gas LG to selectively flow from the first pressure vessel 10 toward the second pressure vessel 20, a gas supply path 33 configured to allow the gas G generated in the second pressure vessel 20 to selectively flow toward the gas utilization unit 100, and the control unit 70 configured to control the operation of each device of the gas supply device 2.

The gas supply device 2 includes a vent path 32 configured to allow the gas G generated in the second pressure vessel 20 to selectively flow toward a gap inside the first pressure vessel 10 when the liquefied gas LG is supplied from the first pressure vessel 10 to the second pressure vessel 20.

In FIG. 6 and the like, arrows illustrated between the respective pressure vessels indicate orientations in which the liquefied gas LG or the gas G circulates. In FIG. 6 and the like, a horizontal direction (H) and a vertical direction (V) are defined as illustrated. In the description of the embodiment, when an upper side or a lower side, or being high or being low is referred to, an upper side or a lower side, or being high or being low in the vertical direction (V) is referred to.

### First Pressure Vessel 10: See FIG. 6

Similarly to the first embodiment, the first pressure vessel 10 internally stores the liquefied gas LG, and supplies the second pressure vessel 20 with the liquefied gas LG that is stored. The first pressure vessel 10 is subjected to heat insulating treatment for reducing heat input to the first pressure vessel 10 so that the liquefied gas LG is maintained in a liquid state.

As illustrated in FIG. 6, the first pressure vessel 10 includes the pressure vessel body 11 that internally stores the liquefied gas LG, the first pressure detecting unit 12 that detects the pressure of the inside of the pressure vessel body 11, and the filling valve 13 connected to a liquefied gas supply source (not illustrated) in order to fill the pressure vessel body 11 with the liquefied gas LG from the outside. A liquid surface detecting unit (not illustrated) detects the storage amount of the liquefied gas LG in the pressure vessel body 11, and the control unit 70 receives the detection result.

The first pressure vessel 10 is disposed at a position higher than the second pressure vessel 20 in the vertical direction (V).

### Second Pressure Vessel 20: See FIG. 6

Similarly to the first embodiment, the second pressure vessel 20 vaporizes the liquefied gas LG supplied from the first pressure vessel 10, and supplies the gas G after vaporization to the gas utilization unit 100. Similarly to the second A pressure vessel 20 and the second B pressure vessel 40, the second pressure vessel 20 is subjected to heat insulating treatment and allows heat input.

As illustrated in FIG. 6, the second pressure vessel 20 includes the pressure vessel body 21 that vaporizes the liquefied gas LG supplied from the first pressure vessel 10 via the liquefied gas supply path 31. The liquid surface detecting unit (not illustrated) detects the storage amount of the liquefied gas LG in the pressure vessel body 21, and the control unit 70 acquires the detection result. The control unit 70 having received the detection result determines whether the supply amount of the liquefied gas LG to the second pressure vessel 20 has reached a predetermined supply amount and whether the liquefied gas LG has been entirely vaporized.

Furthermore, the second pressure vessel 20 includes the first liquefied gas supply valve 22 connected to the liquefied gas supply path 31 and configured to switch between start and stop of supply of the liquefied gas LG supplied from the first pressure vessel 10, the vent valve 23 connected to the first vent path 32 and configured to switch between start and stop of circulation of the gas G to the first pressure vessel 10, and the gas supply valve 24 provided midway in the gas supply path 33 and configured to switch between start and stop of supply of the gas G to the gas utilization unit 100.

The second A pressure vessel 20 includes the second pressure detecting unit 25 that detects the pressure of the gas G inside the pressure vessel body 21 and the heat input unit 26 that inputs heat to the pressure vessel body 21.

### Control Unit 70: See FIG. 6

The control unit 70 controls the operation of each device of the gas supply device 1.

The control unit 70 controls switching of opening/closing of each of the liquefied gas supply valve 22, the vent valve 23, and the gas supply valve 24. The control unit 70 receives detection results of the first pressure detecting unit 12 and the second pressure detecting unit 25. The control unit 70 may control switching of opening/closing of each valve based on detection results of the first pressure detecting unit 12 and the second pressure detecting unit 25.

The control unit 70 includes an output unit (not illustrated) that issues, to the worker, an alarm regarding the state of the gas supply device 1. For example, the output unit issues, to the worker, an alarm that the upper limit filling amount of the liquefied gas LG in the first pressure vessel 10 has been reached.

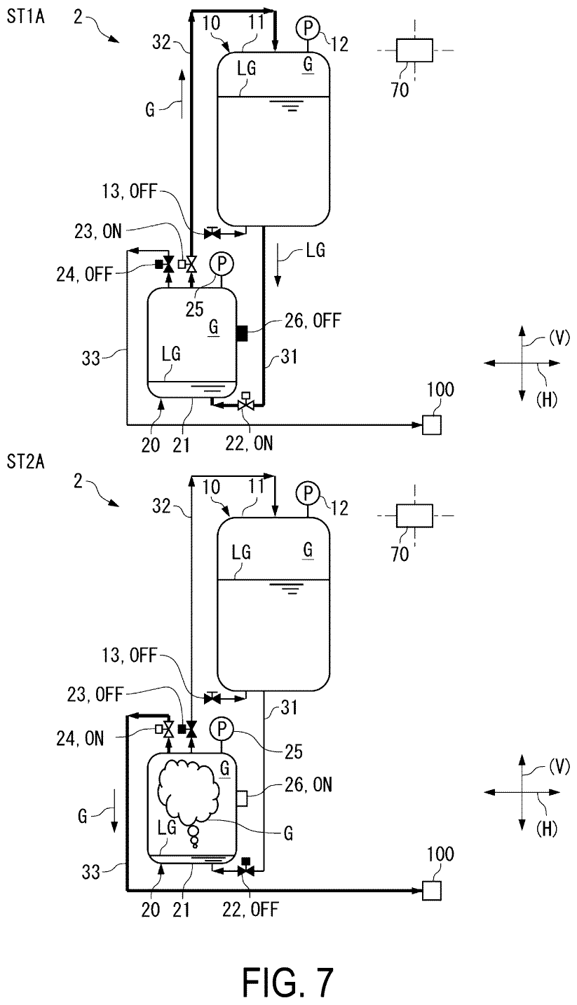

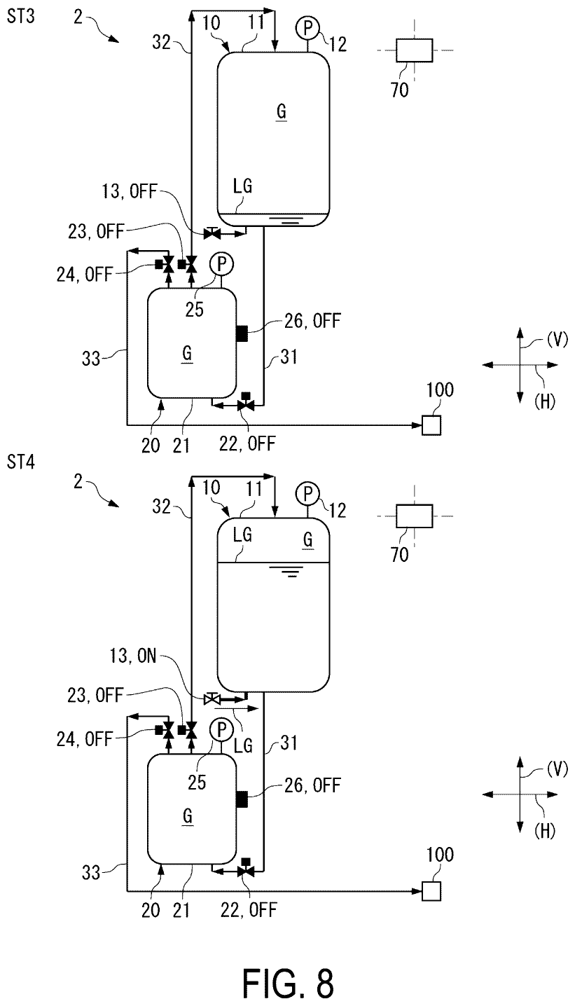

### Gas Generation and Supply Procedure: See FIGS. 7 and 8

Hereinafter, a generating and supplying procedure of the gas G in the gas supply device 2 will be described with reference to FIGS. 7 and 8.

Note that the generating and supplying procedure of the gas G described below is performed in accordance with an instruction from the control unit 70. Before this procedure is started, inside of the first pressure vessel 10 and the second pressure vessel 20 is replaced with the gas G obtained by vaporizing the liquefied gas LG, for example. In addition, inside of the first pressure vessel 10 and the second pressure vessel 20 may be in a state of medium vacuum (JIS Z 8126-1) of less than 100 Pa and 0.1 Pa or more. Note that it is assumed that before the procedure is started, the first pressure vessel 10 is filled with the liquefied gas LG and all the valves are closed.

In the drawings, a state in which the valve is opened is in white and “ON” is written together with the reference sign, a state in which the valve is closed is in black and “OFF” is written together with the reference sign. The heat input state of the first heat input unit 26 is in white and “ON” is written together with the reference sign, the heat input stop state is in black and “OFF” is written together with the reference sign.

In the procedure, supply (first step) of the liquefied gas LG from the first pressure vessel 10 to the second pressure vessel 20 and supply (second step) of the gas G from the second pressure vessel 20 to the gas utilization unit 100 are alternately repeated. That is, when the liquefied gas LG is supplied from the first pressure vessel 10 to the second pressure vessel 20, the supply of the gas G from the second pressure vessel 20 to the gas utilization unit 100 is stopped. When the supply of the liquefied gas LG from the first pressure vessel 10 to the second pressure vessel 20 is stopped, the gas G is supplied from the second pressure vessel 20 to the gas utilization unit 100.

The gas G can be intermittently supplied to the gas utilization unit 100 until the liquefied gas LG inside the first pressure vessel 10 reaches the lower limit storage amount.

### First Step: See ST1A in FIG. 7

In the first step, the liquefied gas supply valve 22 and the vent valve 23 are opened. Due to this, the liquefied gas LG is supplied from the first pressure vessel 10 to the second pressure vessel 20 via the liquefied gas supply path 31, and the gas G stored in the second pressure vessel 20 is circulated to the first pressure vessel 10 via the vent path 32.

Note that the opening/closing state of the valve in the first step is summarized below.
Open (ON): liquefied gas supply valve 22, vent valve 23
Close (OFF): gas supply valve 24, filling valve 13

### Second Step: See ST2A in FIG. 7

Subsequent to the first step, the second step is executed.

In the second step, the liquefied gas supply valve 22 and the vent valve 23 are closed. Due to this, the supply of the liquefied gas from the first pressure vessel 10 to the second pressure vessel 20 is stopped, and the supply of the gas G to the first pressure vessel 10 via the vent path 32 is also stopped.

In the second step, the liquefied gas LG stored in the second pressure vessel 20 is vaporized by inputting heat from the heat input unit 26.

In the second step, by opening of the gas supply valve 24, the gas G is supplied from the second pressure vessel 20 to the gas utilization unit 100 via the gas supply path 33. Note that the gas supply valve 24 may be opened based on the detection result of the second pressure detecting unit 25. The gas supply valve 24 may be opened, for example, after the pressure of the gas G detected by the second pressure detecting unit 25 reaches the pressure required for the gas utilization unit 100.

Note that the opening/closing state of the valve in the second step is summarized below.
Open (ON): gas supply valve 24
Close (OFF): liquefied gas supply valve 22, vent valve 23, filling valve

### Third Step: See ST3 in FIG. 8

When the liquefied gas LG stored in the first pressure vessel 10 has the lower limit filling amount or less, subsequent to the second step, the third step is executed.

In the third step, after the liquefied gas LG inside the second pressure vessel 20 is entirely vaporized in the second step, the gas supply valve 24 is closed. Due to this, the supply of the gas G from the second pressure vessel 20 to the gas utilization unit 100 is stopped.

Note that whether the filling amount is the lower limit filling amount or less is determined by the control unit 70 having received the detection result detected by the liquid surface detecting unit (not illustrated).

Note that the opening/closing state of the valve in the third step is summarized below.
Open (ON): none
Close (OFF): liquefied gas supply valve 22, vent valve 23, gas supply valve 24, filling valve 13

### Fourth Step: See ST4 in FIG. 8

Subsequent to the third step, the fourth step is executed.

In the fourth step, the filling valve 13 connected to the supply source (not illustrated) of the liquefied gas LG is opened by the worker, thereby starting filling of the liquefied gas LG into the first pressure vessel 10. When the liquefied gas LG in the first pressure vessel 10 reaches the upper limit filling amount, the filling valve 13 is closed by the worker to stop the filling of the liquefied gas LG into the first pressure vessel 10. Note that whether the filling amount has reached the upper limit filling amount is determined by the control unit 70 having received the detection result detected by the liquid surface detecting unit (not illustrated), and when the filling amount of the liquefied gas LG has reached the upper limit filling amount, an output unit included in the control unit 70 issues an alarm to the worker.

After the filling of the liquefied gas LG into the first pressure vessel 10 is completed, the supply of the liquefied gas LG to the second pressure vessel 20 is resumed. After the supply of the liquefied gas LG into the second pressure vessel 20 is stopped, the supply of the gas G from the second pressure vessel 20 to the gas utilization unit 100 is resumed.

### Effects

The gas supply device 2 according to the present embodiment described above achieves the same effects as the first effect, the second effect, the fourth effect, and the fifth effect.

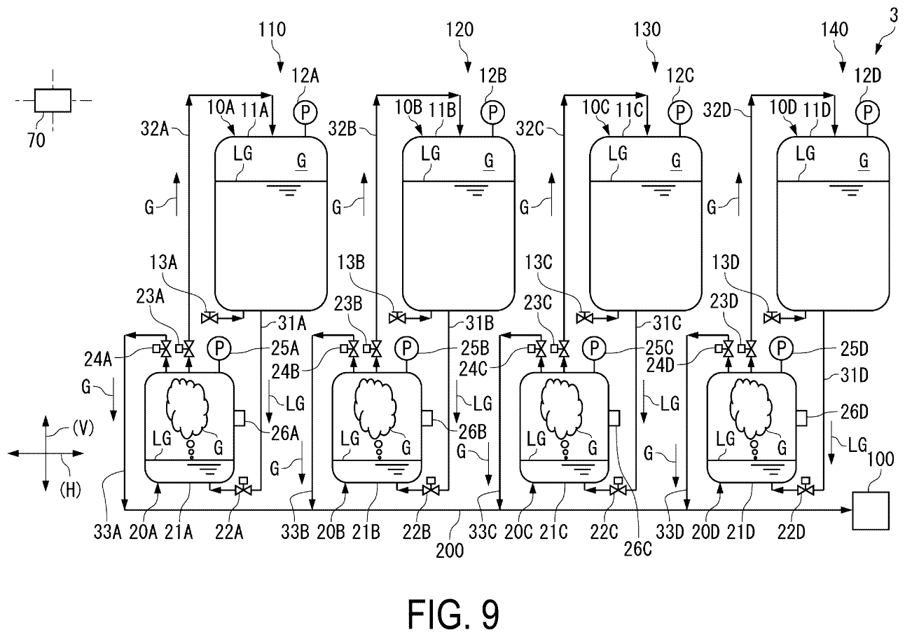

### Modification of Gas Supply Device 2: See FIG. 9

As a modification of the gas supply device 2, for example, a gas supply device 3 parallelly provided with a plurality of gas supply units having configurations of the first pressure vessel 10 and the second pressure vessel 20 of the gas supply device 2 will be described. The gas supply unit is an example of the gas supply device of the disclosure.

The gas supply device 2 performs only intermittent supply of the gas G. However, the gas supply device 3 including the plurality of gas supply units 110, 120, 130, and 140 parallelly connected to the gas utilization unit 100 can continuously supply the gas G by switching the gas supply units 110, 120, 130, and 140 that supply the gas G. The gas supply device 1 of the first embodiment is provided with two pressure vessels that vaporize the liquefied gas LG and supply the gas G to the gas utilization unit 100 for one first pressure vessel 10 in which the liquefied gas LG is stored. The two pressure vessels 20 and 40 are connected to the gas utilization unit 100 in parallel. The two pressure vessels 20 and 40 are connected to the first pressure vessel 10 in parallel.

The gas supply device 3 is different from the gas supply device 1 in that the first pressure vessels 10A, 10B, 10C, and 10D in which the liquefied gas LG is stored and the second pressure vessels 20A, 20B, 20C, and 20D that vaporize the liquefied gas LG and supply the gas G to the gas utilization unit 100 are provided in a one-to-one correspondence, whereas the gas supply device 1 is provided with the second A pressure vessel 20 and the second B pressure vessel 40 for one first pressure vessel 10, that is, provided in a one-to-two correspondence.

By including the second A pressure vessel 20 and the second B pressure vessel 40, the gas supply device 1 can continuously supply the gas. In order to enable continuous supply of the gas G to the gas utilization unit 100, the gas supply device 3 includes at least two gas supply units 110 and 120. For example, the gas supply device 3 includes two first pressure vessels 10A and 10B having large capacities and two second pressure vessels 20A and 20B.

Note that since in the gas supply device 1, the number of the first pressure vessels 10 having large capacities can be reduced by 1, the volume occupied by the gas supply device 1 is smaller than that of the gas supply device 3.

As illustrated in FIG. 9, the gas supply device 3 includes the control unit 70 that controls the operation of each device of the gas supply device 3. The gas supply device 3 includes a first gas supply unit 110 including a first pressure vessel 10A in which the liquefied gas LG is stored, a second pressure vessel 20A configured to generate the gas G by vaporizing the liquefied gas LG supplied from the first pressure vessel 10A, a liquefied gas supply path 31A configured to allow the liquefied gas LG to selectively flow from the first pressure vessel 10A toward the second pressure vessel 20A, a vent path 32A configured to allow the gas G generated in the second pressure vessel 20A to selectively flow toward a gap inside the first pressure vessel 10A when the liquefied gas LG is supplied from the first pressure vessel 10A to the second pressure vessel 20A, and a gas supply path 33A configured to allow the gas G generated in the second pressure vessel 20A to selectively flow toward the gas utilization unit 100.

The gas supply device 3 includes a second gas supply unit 120 including a first pressure vessel 10B in which the liquefied gas LG is stored, a second pressure vessel 20B configured to generate the gas G by vaporizing the liquefied gas LG supplied from the first pressure vessel 10B, a liquefied gas supply path 31B configured to allow the liquefied gas LG to selectively flow from the first pressure vessel 10B toward the second pressure vessel 20B, a vent path 32B configured to allow the gas G generated in the second pressure vessel 20B to selectively flow toward a gap inside the first pressure vessel 10B when the liquefied gas LG is supplied from the first pressure vessel 10B to the second pressure vessel 20B, and a gas supply path 33B configured to allow the gas G generated in the second pressure vessel 20B to selectively flow toward the gas utilization unit 100.

The gas supply device 3 includes a third gas supply unit 130 including a first pressure vessel 10C in which the liquefied gas LG is stored, a second pressure vessel 20C configured to generate the gas G by vaporizing the liquefied gas LG supplied from the first pressure vessel 10C, a liquefied gas supply path 31C configured to allow the liquefied gas LG to selectively flow from the first pressure vessel 10C toward the second pressure vessel 20C, a vent path 32C configured to allow the gas G generated in the second pressure vessel 20C to selectively flow toward a gap inside the first pressure vessel 10C when the liquefied gas LG is supplied from the first pressure vessel 10C to the second pressure vessel 20C, and a gas supply path 33C configured to allow the gas G generated in the second pressure vessel 20C to selectively flow toward the gas utilization unit 100.

Furthermore, the gas supply device 3 includes a fourth gas supply unit 140 including a first pressure vessel 10D in which the liquefied gas LG is stored, a second pressure vessel 20D configured to generate the gas G by vaporizing the liquefied gas LG supplied from the first pressure vessel 10D, a liquefied gas supply path 31D configured to allow the liquefied gas LG to selectively flow from the first pressure vessel 10D toward the second pressure vessel 20D, a vent path 32D configured to allow the gas G generated in the second pressure vessel 20D to selectively flow toward a gap inside the first pressure vessel 10D when the liquefied gas LG is supplied from the first pressure vessel 10D to the second pressure vessel 20D, and a gas supply path 33D configured to allow the gas G generated in the second pressure vessel 20D to selectively flow toward the gas utilization unit 100.

The gas supply device 3 includes a merging gas supply path 200 to which the gas supply paths 33A, 33B, 33C, and 33D are connected and that is connected to the gas utilization unit 100.

By including the plurality of gas supply units 110, 120, 130, and 140 parallelly connected to the gas utilization unit 100, for example, when the gas G is supplied from the fourth gas supply unit 140 to the gas utilization unit 100, the gas supply device 3 can supply the liquefied gas LG from the first pressure vessels 10A, 10B, and 10C to the second pressure vessels 20A, 20B, and 20C in the other three gas supply units 110, 120, and 130. Alternatively, the liquefied gas LG can be vaporized in the second pressure vessels 20A, 20B, and 20C. The gas supply device 3 can continuously supply the gas G to the gas utilization unit 100 by, for example, sequentially switching the supply of the gas G to the gas utilization unit 100 among the plurality of gas supply units 110, 120, 130, and 140 connected to the gas utilization unit 100 in parallel.

For example, when the liquefied gas LG inside the second pressure vessel 20D of the fourth gas supply unit 140 is entirely vaporized, the supply of the gas G from the fourth gas supply unit 140 to the gas utilization unit 100 is stopped. Along with stopping of the supply of the gas G from the fourth gas supply unit 140, the supply of the gas G to the gas utilization unit 100 from, for example, a gas supply unit, from among the other gas supply units, having the highest pressure of the gas G inside the second pressure vessels 20A, 20B, and 20C is started.

Determination as to which of the gas supply unit 110, 120, 130, and 140 the gas G is supplied from is made based on a gas supply condition set in the control unit 70, for example. The gas supply condition may be based on the pressure of the gas G inside the second pressure vessels 20A, 20B, 20C, and 20D described above. In addition, the gas G may be supplied from the first gas supply unit 110 in ascending order.

### Effects

The gas supply device 3 according to the present embodiment described above achieves the same effects as the first effect to the fifth effect.

### Supplementary Notes

The gas supply device according to the disclosure can be understood as follows.

### Supplementary Note 1

A gas supply device (1, 2) according to the disclosure includes a first pressure vessel (10) in which liquefied gas is stored, a second pressure vessel (20, 40) configured to generate gas (G) by vaporizing the liquefied gas (LG) supplied from the first pressure vessel (10), a liquefied gas supply path (31, 51) configured to allow the liquefied gas (LG) to selectively flow from the first pressure vessel (10) toward the second pressure vessel (20, 40), and a gas supply path (33, 53) configured to allow the gas (G) generated in the second pressure vessel (20, 40) to selectively flow toward a gas utilization unit (100).

### Supplementary Note 2

Preferably, in Supplementary Note 1, the second pressure vessel (20, 40) includes a second A pressure vessel (20) and a second B pressure vessel (40), the liquefied gas supply path (31, 51) includes a first liquefied gas supply path (31) connecting the first pressure vessel (10) and the second A pressure vessel (20) and a second liquefied gas supply path (51) connecting the first pressure vessel (10) and the second B pressure vessel (40), and the gas supply path (33, 53) includes a first gas supply path (33) configured to allow the gas (G) generated in the second A pressure vessel (20) to flow toward the gas utilization unit (100) and a second gas supply path (53) configured to allow the gas (G) generated in the second B pressure vessel (40) to flow toward the gas utilization unit (100).

### Supplementary Note 3

Preferably, in Supplementary Note 1, a liquefied gas supply valve (22, 42) provided midway in the liquefied gas supply path (31, 51) and configured to switch between start and stop of supply of the liquefied gas (LG) supplied from the first pressure vessel (10) and a gas supply valve (24, 44) provided midway in the gas supply path (33, 53) and configured to switch between start and stop of supply of the gas (G) to the gas utilization unit (100) are included.

### Supplementary Note 4

Preferably, in Supplementary Note 2, a first liquefied gas supply valve (22) provided midway in the first liquefied gas supply path (31) and configured to switch between start and stop of supply of liquefied gas (LG) supplied from the first pressure vessel (10), a first gas supply valve (24) provided midway in the first gas supply path (33) and configured to switch between start and stop of supply of the gas (G) to the gas utilization unit (100), a second liquefied gas supply valve (42) provided midway in the second liquefied gas supply path (51) and configured to switch between start and stop of supply of the liquefied gas (LG) supplied from the first pressure vessel (10), and a second gas supply valve (44) provided midway in the second gas supply path (53) and configured to switch between start and stop of supply of the gas (G) to the gas utilization unit (100) are included.

### Supplementary Note 5

Preferably, in Supplementary Note 1 or 3, a heat input unit (26) configured to input heat to the second pressure vessel (20, 40) is included.

### Supplementary Note 6

Preferably, in Supplementary Note 2 or 4, a first heat input unit (26) configured to input heat to the second A pressure vessel (20) and a second heat input unit (46) configured to input heat to the second B pressure vessel (40) are included.

### Supplementary Note 7

Preferably, in any of Supplementary Note 1, 3 or 5, the first pressure vessel (10) is disposed at a position higher than the second pressure vessel (20, 40) in a vertical direction.

### Supplementary Note 8

Preferably, in any of Supplementary Note 2, 4, or 6, the first pressure vessel (10) is disposed at a position higher than the second A pressure vessel (20) and the second B pressure vessel (40) in a vertical direction.

### Supplementary Note 9

Preferably, in any of Supplementary Note 1, 3, 5, or 7, a vent path (32, 52) configured to allow part of the gas (G) generated in the second pressure vessel (20, 40) to selectively flow toward a gap inside the first pressure vessel (10) is included, and a first step of causing the liquefied gas (LG) to flow from the liquefied gas supply path (31, 51) toward the second pressure vessel (20, 40) and causing the gas (G) stored in the second pressure vessel (20, 40) to flow via the vent path (32, 52) and a second step of supplying the gas (G) toward the gas utilization unit (100) via the gas supply path (33, 53) while generating the gas (G) by vaporizing the liquefied gas (LG) stored in the second pressure vessel (20, 40) are executed in sequence.

### Supplementary Note 10

Preferably, in any of Supplementary Note 2, 4, 6, or 8, a first vent path (32) configured to allow part of the gas (G) generated in the second A pressure vessel (20) to selectively flow toward a gap inside the first pressure vessel (10) and a second vent path (52) configured to allow part of the gas (G) generated in the second B pressure vessel (40) to selectively flow toward a gap inside the first pressure vessel (10) are included, and a first A step of causing the liquefied gas (LG) to flow from the first liquefied gas supply path (31) toward the second A pressure vessel (20) and causing the gas (G) stored in the second A pressure vessel (20) to flow via the first vent path (32), a second A step of, subsequent to the first A step, supplying the gas (G) toward the gas utilization unit (100) via the first gas supply path (33) while generating the gas (G) by vaporizing the liquefied gas (LG) stored in the second A pressure vessel (20), a first B step of, while the second A step is being executed, causing the liquefied gas (LG) to flow from the second liquefied gas supply path (51) toward the second B pressure vessel (40) and causing the gas (G) stored in the second B pressure vessel (40) to flow via the second vent path (52), and a second B step of, subsequent to the first B step, supplying the gas (G) toward the gas utilization unit (100) via the second gas supply path (53) while generating the gas (G) by vaporizing the liquefied gas (LG) stored in the second B pressure vessel (40) are executed.

### Supplementary Note 11

Preferably, in Supplementary Note 1, at least two gas supply devices (2) according to Supplementary Note 1 are included, and the gas supply devices (2) are connected to the gas utilization unit (100) in parallel.

### Supplementary Note 12

A gas supply method according to the disclosure is a method for supplying, to a gas utilization unit (100), gas (G) obtained by vaporizing liquefied gas (LG), the method including a first step of supplying the liquefied gas (LG) to a second pressure vessel (20, 40) from a first pressure vessel (10) in which the liquefied gas (LG) is stored, and a second step of, subsequent to the first step, supplying the gas (G) toward the gas utilization unit (100) while generating the gas (G) by vaporizing the liquefied gas (LG) stored in the second pressure vessel (20, 40).

### Supplementary Note 13

A gas supply method according to the disclosure is a method for supplying, to a gas utilization unit (100), gas (G) obtained by vaporizing liquefied gas (LG), the method including a first A step of supplying the liquefied gas (LG) to a second A pressure vessel (20) from a first pressure vessel (10) in which the liquefied gas (LG) is stored, a second A step of, subsequent to the first A step, supplying the gas (G) toward the gas utilization unit (100) while generating the gas (G) by vaporizing the liquefied gas (LG) stored in the second A pressure vessel (20), a first B step of, while the second A step is being executed, supplying the liquefied gas (LG) from the first pressure vessel (10) to a second B pressure vessel (40), and a second B step of, subsequent to the first B step, supplying the gas (G) toward the gas utilization unit (100) while generating the gas (G) by vaporizing the liquefied gas (LG) stored in the second B pressure vessel (40).

Besides the above, configurations described in the above-described embodiments can be selected or omitted or can be changed to other configurations, as necessary.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A gas supply device comprising:
a first pressure vessel in which liquefied gas is stored;
a second pressure vessel configured to generate gas by vaporizing the liquefied gas supplied from the first pressure vessel;
a liquefied gas supply path configured to allow the liquefied gas to selectively flow from the first pressure vessel toward the second pressure vessel; and
a gas supply path configured to allow the gas generated in the second pressure vessel to selectively flow toward a gas utilization unit.

2. The gas supply device according to claim 1, wherein
the second pressure vessel includes a second A pressure vessel and a second B pressure vessel,
the liquefied gas supply path includes a first liquefied gas supply path connecting the first pressure vessel and the second A pressure vessel and a second liquefied gas supply path connecting the first pressure vessel and the second B pressure vessel, and
the gas supply path includes a first gas supply path configured to allow the gas generated in the second A pressure vessel to flow toward the gas utilization unit and a second gas supply path configured to allow the gas generated in the second B pressure vessel to flow toward the gas utilization unit.

3. The gas supply device according to claim 1, further comprising:
a liquefied gas supply valve provided midway in the liquefied gas supply path and configured to switch between start and stop of supply of the liquefied gas supplied from the first pressure vessel; and
a gas supply valve provided midway in the gas supply path and configured to switch between start and stop of supply of the gas to the gas utilization unit.

4. The gas supply device according to claim 2, further comprising:
a first liquefied gas supply valve provided midway in the first liquefied gas supply path and configured to switch between start and stop of supply of the liquefied gas supplied from the first pressure vessel;
a first gas supply valve provided midway in the first gas supply path and configured to switch between start and stop of supply of the gas to the gas utilization unit;
a second liquefied gas supply valve provided midway in the second liquefied gas supply path and configured to switch between start and stop of supply of the liquefied gas supplied from the first pressure vessel; and
a second gas supply valve provided midway in the second gas supply path and configured to switch between start and stop of supply of the gas to the gas utilization unit.

5. The gas supply device according to claim 1, further comprising:
a heat input unit configured to input heat to the second pressure vessel.

6. The gas supply device according to claim 3, further comprising:
a heat input unit configured to input heat to the second pressure vessel.

7. The gas supply device according to claim 2, further comprising:
a first heat input unit configured to input heat to the second A pressure vessel; and
a second heat input unit configured to input heat to the second B pressure vessel.

8. The gas supply device according to claim 4, further comprising:
a first heat input unit configured to input heat to the second A pressure vessel; and
a second heat input unit configured to input heat to the second B pressure vessel.

9. The gas supply device according to claim 1,
wherein the first pressure vessel is disposed at a position higher than the second pressure vessel in a vertical direction.

10. The gas supply device according to claim 2,
wherein the first pressure vessel is disposed at a position higher than the second A pressure vessel and the second B pressure vessel in a vertical direction.

11. The gas supply device according to claim 1, further comprising:
a vent path configured to allow part of the gas generated in the second pressure vessel to selectively flow toward a gap inside the first pressure vessel,
wherein a first step of causing the liquefied gas to flow from the liquefied gas supply path toward the second pressure vessel and causing the gas stored in the second pressure vessel to flow via the vent path, and
a second step of supplying the gas toward the gas utilization unit via the gas supply path while generating the gas by vaporizing the liquefied gas stored in the second pressure vessel are executed in sequence.

12. The gas supply device according to claim 9, further comprising:
a vent path configured to allow part of the gas generated in the second pressure vessel to selectively flow toward a gap inside the first pressure vessel,
wherein a first step of causing the liquefied gas to flow from the liquefied gas supply path toward the second pressure vessel and causing the gas stored in the second pressure vessel to flow via the vent path, and
a second step of supplying the gas toward the gas utilization unit via the gas supply path while generating the gas by vaporizing the liquefied gas stored in the second pressure vessel are executed in sequence.

13. The gas supply device according to claim 2, further comprising:
a first vent path configured to allow part of the gas generated in the second A pressure vessel to selectively flow toward a gap inside the first pressure vessel; and
a second vent path configured to allow part of the gas generated in the second B pressure vessel to selectively flow toward a gap inside the first pressure vessel,
wherein a first A step of causing the liquefied gas to flow from the first liquefied gas supply path toward the second A pressure vessel and causing the gas stored in the second A pressure vessel to flow via the first vent path,
a second A step of, subsequent to the first A step, supplying the gas toward the gas utilization unit via the first gas supply path while generating the gas by vaporizing the liquefied gas stored in the second A pressure vessel,
a first B step of, while the second A step is being executed, causing the liquefied gas to flow from the second liquefied gas supply path toward the second B pressure vessel and causing the gas stored in the second B pressure vessel to flow via the second vent path, and
a second B step of, subsequent to the first B step, supplying the gas toward the gas utilization unit via the second gas supply path while generating the gas by vaporizing the liquefied gas stored in the second B pressure vessel are executed.

14. The gas supply device according to claim 10, further comprising:
a first vent path configured to allow part of the gas generated in the second A pressure vessel to selectively flow toward a gap inside the first pressure vessel; and
a second vent path configured to allow part of the gas generated in the second B pressure vessel to selectively flow toward a gap inside the first pressure vessel,
wherein a first A step of causing the liquefied gas to flow from the first liquefied gas supply path toward the second A pressure vessel and causing the gas stored in the second A pressure vessel to flow via the first vent path,
a second A step of, subsequent to the first A step, supplying the gas toward the gas utilization unit via the first gas supply path while generating the gas by vaporizing the liquefied gas stored in the second A pressure vessel,
a first B step of, while the second A step is being executed, causing the liquefied gas to flow from the second liquefied gas supply path toward the second B pressure vessel and causing the gas stored in the second B pressure vessel to flow via the second vent path, and
a second B step of, subsequent to the first B step, supplying the gas toward the gas utilization unit via the second gas supply path while generating the gas by vaporizing the liquefied gas stored in the second B pressure vessel are executed.

15. A gas supply device comprising:
at least two gas supply devices according to claim 1,
wherein the gas supply devices are connected to the gas utilization unit in parallel.

16. A gas supply method for supplying, to a gas utilization unit, gas obtained by vaporizing liquefied gas, the gas supply method comprising:
a first step of supplying the liquefied gas to a second pressure vessel from a first pressure vessel in which the liquefied gas is stored; and
a second step of, subsequent to the first step, supplying the gas toward the gas utilization unit while generating the gas by vaporizing the liquefied gas stored in the second pressure vessel.

17. A gas supply method for supplying, to a gas utilization unit, gas obtained by vaporizing liquefied gas, the gas supply method comprising:
a first A step of supplying the liquefied gas to a second A pressure vessel from a first pressure vessel in which the liquefied gas is stored;
a second A step of, subsequent to the first A step, supplying the gas toward the gas utilization unit while generating the gas by vaporizing the liquefied gas stored in the second A pressure vessel;
a first B step of, while the second A step is being executed, supplying the liquefied gas from the first pressure vessel to a second B pressure vessel; and
a second B step of, subsequent to the first B step, supplying the gas toward the gas utilization unit while generating the gas by vaporizing the liquefied gas stored in the second B pressure vessel.
